(19) United States
(12) Patent Application Publication
(10) Pub. No.: US 2025/0198383 A1
(43) Pub. Date: Jun. 19, 2025

(54) WIND HARNESS FOR A VEHICLE

(71) Applicant: FCA US LLC, Auburn Hills, MI (US)

(72) Inventor: Azard Mohammed Shaik, Troy, MI (US)

(21) Appl. No.: 18/542,945

(22) Filed: Dec. 18, 2023

(51) Int. Cl. F03D 9/32; B62D 25/04

(52) U.S. Cl. CPC F03D 9/32; B62D 25/04; F05B 2240/941

(57) ABSTRACT

A wind harness for a vehicle includes a low profile duct intake that extends along a roof and sides of a vehicle. At least one duct extends from the duct intake on each side of the vehicle. The ducts are positioned in the rear pillars directing air and through along the pillars. A wind turbine is positioned inside a body panel of the vehicle. The ducts have an exhaust nozzle directed at the turbine for delivering an air flow to rotate the turbine.

### FIELD

The present disclosure relates to vehicles and, more particularly, to a wind harness utilizing wind to produce electrical energy.

### BACKGROUND

This section provides background information related to the present disclosure which is not necessarily prior art.

In automotive vehicles, when they are moving, they are constantly exposed to a wind force. Ordinarily, as the vehicle speed increases, the force of the wind on and around the vehicle increases. Thus, there is wind present at a significant speed on the vehicle. Thus, it would be desirable to utilize the wind speed and force to generate electricity via a wind turbine. Several different types of electrical generation devices have been provided in the art. However, these devices have drawbacks when applying them to the vehicle to generate electricity.

Thus, it would be desirable to utilize the wind force hitting the vehicle and harnessing the wind to generate electricity. Accordingly, the present disclosure provides a wind harnessing device.

The present device provides a wind harness having openings in the back roof of the vehicle. The harness may project to the left and right sides of the vehicle to enable the wind to flow into the harness. The wind harness runs wind turbines when the car is moving so that the air flows through the harness and generates electricity via a wind turbine.

### SUMMARY

This section provides a general summary of the disclosure, and is not a comprehensive disclosure of its full scope or all of its features.

According to a first aspect of the disclosure, a vehicle wind harness comprises a low profile intake extending along a roof and sides of a vehicle. At least one duct extends from an intake on each side of the vehicle. The ducts are positioned in the rear pillars to direct the airflow along the pillars. A wind turbine is positioned inside a body panel of the vehicle. The ducts have an exhaust directed at the wind turbine to rotate the turbine to produce electricity. A plurality of ducts may be on each side of the vehicle. The intake is part of the roof panel. The intake extends 3 cm to 6 cm above the roof and sides of the vehicle. The air exits the panels below the vehicle.

According to a second aspect of the disclosure, a vehicle with a wind harness comprises a roof with side pillars connecting the roof to a body. A vehicle wind harness has a low profile intake extending along the roof and sides of the vehicle. At least one duct extends from an intake on each side of the vehicle. The ducts are positioned in the rear pillars to direct the airflow along the pillars. A wind turbine is positioned inside a body panel of the vehicle. The ducts have an exhaust directed at the wind turbine to rotate the turbine to produce electricity. A plurality of ducts may be on each side of the vehicle. The intake is part of the roof panel. The intake extends 3 cm to 6 cm above the roof and sides of the vehicle. The air exits the panels below the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic elevation view of a vehicle with a wind harness.

FIG. 2 is a schematic view of the wind harness in the vehicle.

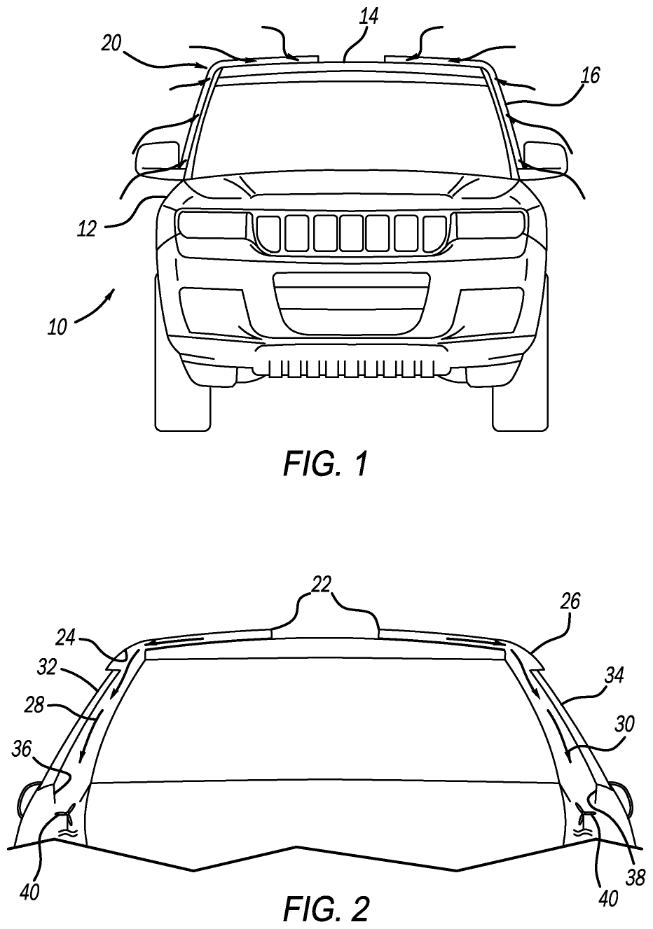

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle 10 includes a body 12 with a roof panel 14. The roof panel 14 is continuous with the body via the side pillars 16. A wind harness 20 is integrated into the roof 14.

The harness 20 includes roof ducts 22 and side ducts 24, 26. The roof duct 22 may extend continuously across the roof or it may be divided into portions as shown. The roof duct 22 and side ducts 24, 26 are low profile and extend about 3 cm to 6 cm from the roof and side pillars.

The roof duct 22 and side ducts 24, 26 include intakes to direct the airflow into channels 28, 30, respectively. The channels 28, 30 are positioned inside of the pillars 32, 34. The channels 28, 30 include exhaust exits 36, 38. The exhaust exits 36, 38 form a nozzle to direct the air flow to the wind turbines 40. The wind turbines 40 are positioned inside of the vehicle body 12. Thus, as the airflow is directed from the channels 28, 30 through the exhaust exits 36, 38 toward the turbines 40, the turbines 40 rotate and, in turn, generate electrical energy. The energy can be passed onto the vehicle batteries. After the air flow passes by the turbines 40, it is directed out of the vehicle, preferably underneath it.

Thus, the wind or air enters the duct intakes and is directed through the channel 28, 30 to the turbines 40. This directs the air while driving the turbines 40 which, in turn, generates electricity. The harness 20 with the ducts 22, 24, 26 may be built into the roof panel 14 and side panels 16 of the vehicle 10. Thus, the low profile of the ducts 22, 24, 26 enables an air collection of the laminate flow as it passes along the body 12. This air flow is, in turn, moved into the channel 28, 30 and directed through the exhaust nozzles 36, 38 to the turbines 40.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wind harness for a vehicle comprising:
a low profile duct intake extending along a roof and sides of a vehicle;
at least one duct extending from the duct intake on each side of the vehicle, the ducts direct the air flow into channels positioned in the rear pillars directing the air flow along and inside the pillars;
a wind turbine is positioned inside a body panel of the vehicle, the channel include an exhaust directed at the turbine for rotating the turbine.

2. The wind harness for a vehicle of claim 1, wherein a plurality of ducts may be on each side of the vehicle.

3. The wind harness for a vehicle of claim 1, wherein the harness ducts are part of the roof.

4. The wind harness for a vehicle of claim 1, wherein the duct intakes extend 3 cm to 6 cm above the roof and sides of the vehicle.

5. The wind harness for a vehicle of claim 1, wherein the air exits below the vehicle.

6. A vehicle with a wind harness comprising:
a roof with side pillars connecting the roof to a body;
a low profile duct intake extending along a roof and sides of a vehicle;
at least one duct extending from the duct intake on each side of the vehicle, the ducts direct the air flow into channels positioned in the rear pillars directing the air flow along and inside the pillars;
a wind turbine positioned inside a body panel of the vehicle, the channel include an exhaust directed at the turbine for rotating the turbine.

7. The vehicle with a wind harness of claim 6, wherein a plurality of ducts may be on each side of the vehicle.

8. The vehicle with a wind harness of claim 6, wherein the harness ducts are part of the roof.

9. The vehicle with a wind harness of claim 6, wherein the duct intakes extend 3 cm to 6 cm above the roof and sides of the vehicle.

10. The vehicle with a wind harness of claim 6, wherein the air exits below the vehicle.
